(19) United States
(12) Patent Application Publication
(10) Pub. No.: US 2010/0006233 A1
(43) Pub. Date: Jan. 14, 2010

(54) LABELING MACHINE IN A BOTTLE OR CONTAINER FILLING PLANT HAVING A TRANSPORT ROLLER, SUCH AS A CUTTING OR SEVERING ROLLER; AND SUCH A ROLLER FOR LABELING EQUIPMENT OR A LABELING ARRANGEMENT, AS WELL AS LABELING EQUIPMENT OR A LABELING ARRANGEMENT

(76) Inventors: Lutz Deckert, Haltern am See (DE); Oliver Kress, Waltrop (DE)

Correspondence Address: NILS H. LJUNGMAN & ASSOCIATES, P. O. BOX 130, GREENSBURG, PA, 15601-0130, US

(21) Appl. No.: 12/352,627

(22) Filed: Jan. 13, 2009

Related U.S. Application Data
(63) Continuation-in-part of application No. PCT/EP2007/006657, filed on Jul. 27, 2007.

(30) Foreign Application Priority Data
Aug. 1, 2006 (DE) 10 2006 035 802.3

(51) Int. Cl. B32B 37/02

(52) U.S. Cl. 156/510

(57) ABSTRACT

A labeling machine in a bottle or container filling plant having a transport roller, such as a cutting or severing roller; and such a roller for labeling equipment or a labeling arrangement, as well as labeling equipment or a labeling arrangement. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/006657, filed on Jul. 27, 2007, which claims priority from Federal Republic of Germany Patent Application No. 10 2006 035 802.3, filed on Aug. 1, 2006. International Patent Application No. PCT/EP2007/006657 was pending as of the filing date of this application. The United States was an elected state in International Patent Application No. PCT/EP2007/006657.

### BACKGROUND

1. Technical Field

The present application relates to a labeling machine in a bottle or container filling plant having a transport roller, such as a cutting or severing roller; and such a roller for labeling equipment or a labeling arrangement, as well as labeling equipment or a labeling arrangement.

2. Background Information

Background is for informational purposes only and does not necessarily admit that subsequently mentioned information and publications are prior art.

Some labeling equipment or labeling arrangements comprise such cutting, or severing rollers—which cutting rollers cooperate with knife shafts that carry the knives, or cutting elements; and at the circumferential wall, or surface of such rollers—prior to severing of the respective label—initially the label material is attached to the circumferential wall by means of a vacuum that is applied by way of vacuum openings and then upon separating, due to the cutting step, also the respective label itself is held correspondingly by the action of a vacuum. It is known, furthermore, to provide such a cutting, or severing drum with interchangeable format parts which provide, or configure, or form the circumferential surface of the cutting, or severing drum. Then the cutting, or severing roller can be optimally adapted by the exchange of the format parts as pertains to the arrangement, and/or to the distribution, and/or to the number of the vacuum openings, and/or concerning the arrangement, and/or the number of the counter knives cooperating with a shaft carrying at least one knife, as pertains to the format, and/or the size of the labels to be affixed on a container.

In the case of these cutting or severing rollers the format parts are configured as segments of a substantially fully cylindrical structure that comprises a mantle surface that hereinafter is also referred to as circular-cylindrical mantle surface, or outer surface, or circumferential surface; and the format parts are fastened by a radially extending fastening arrangement which permits fastening by screwing of the format parts to a carrier member, or carrier structure. It is of detriment herein that, among other things, the considerable mass weight of such cutting or severing rollers is disadvantageous. Furthermore, exchanging of the format parts is time-consuming and complicated in terms of releasing and restoring the pertaining threaded connections.

### OBJECT OR OBJECTS

It is an object, or task of the present application, to provide a transport roller, for example a cutting or severing roller with which the format parts can be rapidly exchanged and without the requirement of a large expenditure. For the solution of this object, or task a transport roller is configured as a transport roller for labels for the use in a labeling equipment or a labeling arrangement, with a circumferential surface that is configured—at a shaft, or shaft arrangement that is configured to be driven so as to rotate—by at least two interchangeable format parts or form parts. Within this circumferential surface, there are provided vacuum openings for the holding, or, respectively, fixing of the labels, or a label material that is configured to provide the labels. The format parts are held by an axially directed clamping force between one in the shaft or shaft arrangement provided carrier element or carrier member and at least one clamping and tensioning device or element that is provided at the shaft or shaft arrangement.

### SUMMARY

The present application relates to a transport roller for labels for the use in labeling equipment or a labeling arrangement, with a circumferential surface that is configured—at a shaft or shaft arrangement that is configured to be driven so as to rotate—by at least two interchangeable format parts, or form parts. Within this circumferential surface, there are provided vacuum openings for the holding, or, respectively, fixing of the labels, or a label material that is configured to provide the labels; and, besides, the present application relates in one possible embodiment to a cutting, or severing roller that is configured for the use with labeling equipment, or labeling arrangements; and, in one possible embodiment, for the processing of so-called “Roll Feed” labels which are formed from an endless strand, or a band of label material, by performance of a cutting, or severing step in a cutting, or severing station comprising the cutting, or severing roller, or drum.

In at least one possible embodiment, the transport roller in accordance with the present application is embodied by the cutting or severing roller of the labeling equipment, or labeling arrangements for the processing of so-called “Roll Feed” labels. A labeling equipment, or labeling arrangement with a transport roller is also disclosed.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Further embodiments are described according to the present application. The present application is explained in the following with reference to the accompanying drawing figures of embodiments of the present application. There is shown in:

FIG. 1 in a simplified, schematic representation the labeling equipment, or labeling arrangement of a labeling machine that is configured for labeling of containers by affixing so-called “Roll Feed” labels to pertaining containers;

FIG. 2 in a perspective view an individual hollow drum-shaped form part arrangement that is comprised of two parts of a cutting, or severing roller of the labeling equipment, or labeling arrangement in accordance with FIG. 1;

FIG. 3 in a perspective view, shown partially in cross-section, the cutting, or severing roller of the labeling equipment, or labeling arrangement, together with the pertaining journal arrangement and the pertaining drive arrangement for this cutting, or severing roller;

FIGS. 4 and 5 an upper end of a shaft, or shaft arrangement of the cutting, or severing roller of the embodiment of FIG. 3, together with a clamping element for securing, or fastening of the form parts in the case of two different embodiment forms;

FIG. 6 a representation similar to FIG. 2, however, together with a grip that is secured to one of the form elements, or format parts;

FIG. 7 is a schematic illustration of a container filling plant in accordance with one embodiment of the present application; and

FIG. 8 is a block diagram of a container filling plant in accordance with one embodiment of the present application.

### DESCRIPTION OF EMBODIMENT OR EMBODIMENTS

In the figures, reference numeral 1 identifies a labeling equipment, or labeling arrangement that forms part of a labeling machine for labeling of containers 2 with so-called “Roll Feed” labels 3 which are drawn off from a supply roller 4 of an endless, strand-like label material 3.1; and the labels 3 are cut off from the label material 3.1, with the pertaining length of a label 3, in a cutting, or severing station 5 of the labeling equipment, or labeling arrangement 1. Afterwards, the labels 3 are transferred, by being passed over a label drum, or transfer drum 6, to the containers 2; which containers 2 are moved—by way of a rotor 7 that is circulating, or rotating about a vertical machine axis of the labeling machine—along the labeling equipment, or labeling arrangement 1, and the labels 3 are then affixed. The directions of rotation of the rotor 7 and of the transfer drum 6 are indicated by the arrow A for the rotor 7, or, respectively, by the arrow B for the drum 6. The label material 3.1 is drawn off from the roller 4, by means of conveyor rollers 8 and 9, in synchronous manner with reference to the rotating movement of the rotor 7, and the material 3.1 is then supplied to the cutting, or severing station 5. This cutting station 5 comprises basically a cutting, or severing roller 10 which roller 10 is driven so as to rotate (schematically indicated by the arrow C) in reference to a vertical axis and, furthermore, the roller 10 comprises a circular-cylindrical circumferential surface 11. The speed with which the cutting, or severing roller 10 turns about its vertical axis is somewhat greater than the speed at which the label material 3.1 is supplied, or introduced, so that this material 3.1 is initially held at the circumferential surface 11 with a certain amount of slip, or slippage; namely, by means of an under pressure, or, respectively, this material 3.1 is held by way of a vacuum.

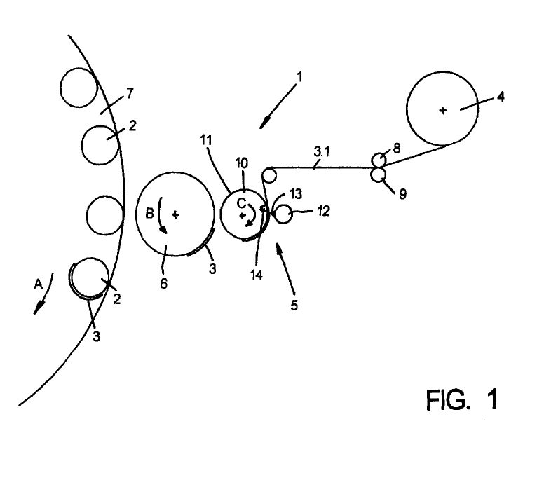

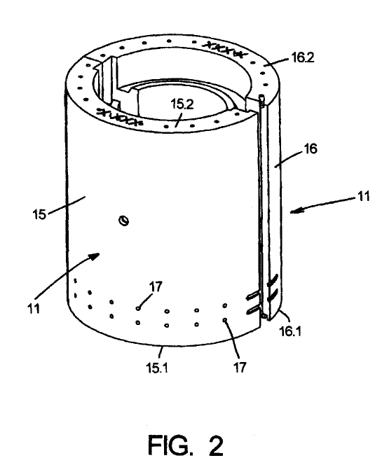

Associated with the cutting, or severing roller 10 is a knife shaft, or knife shaft arrangement 12 that is driven in an oscillating manner around its vertical axis and carries a knife 13; this knife 13 is cooperatively functioning with a counter knife 14 that is provided at the circumferential surface 11 of the cutting, or severing roller 10, the cooperation being in such a way that from the label material 3.1 are separated in each case the labels 3; namely, in the embodiment shown in FIG. 1 in such a way that a label 3 is severed by the sole counter knife 14 upon each rotation of the cutting, or severing roller 10.

So that one is able to use the labeling equipment, or labeling arrangement 1 for labels of various different formats, i.e. with different lengths, and/or heights, and, namely, with a very optimum affixing of the labels 3 and the label material 3.1 at the circumferential surface 11, and with a very low vacuum consumption, the circumferential surface 11 of the cutting, or severing roller 10 is configured in the shown embodiment by two format parts 15 and 16 that can be exchanged. The two format parts are configured in such a way that they are complementary with respect to one another and also are configured in such a way that they, i.e. with the exception of a gap that serves to receive the counter knife 14, configure a structure such as a hollow cylinder having a circular-cylindrical outer surface, or, respectively, a circumferential outer surface, or mantle surface 11, and also a circular-cylindrical inner surface, or mantle surface; and each format part corresponds in each case nearly to one half of a hollow cylinder.

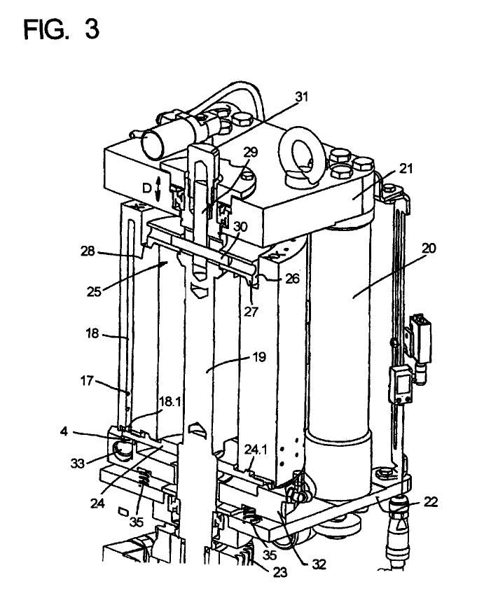

The format parts 15 and 16 are provided—at the circumferential surface 11 that forms the outer, or exterior surface of the cutting, or severing roller 10—with a large number of vacuum openings 17 which are respectively positioned, or configured in an interior manner and which are, respectively, communicating, or terminating in respectively one vacuum channel 18 that is provided in the format part 15 or, respectively, in the format part 16. In the shown embodiment, the vacuum canals 18 are formed in each case by bores, or drill holes which are oriented in substantially parallel manner with respect to the axis of the form part, or format part 15 or, respectively, the format part 16. In the area of the lower edge 15.1 or, respectively, of the lower edge 16.1 of the format part 15 or, respectively, the format part 16 the vacuum canals 18 are configured to permit the pertaining flow in each case into a distributor canal 18.1 which is open in the direction of this underside, or area of the lower edges 15.1 and 16.1, respectively (compare FIG. 3). At the upper side the bores which configure the vacuum canal 18 can be rendered sealingly closed, during use, by pins 18.2.

For utilization at the cutting, or severing roller 10 there is, respectively, provided a set of different format parts 15 or, respectively, format parts 16 which are identical indeed in each case as to their configuration, or styling in which, however, the distribution, and/or the number of the vacuum openings 17 is different, namely according to the format of the labels 3 which are to be processed by the relevant format part 15 or, respectively, the relevant format part 16.

The cutting, or severing roller 10 comprises, furthermore, among other things, a shaft, or shaft arrangement 19 which is journaled for rotation between two boards 21 and 22 that are held at a distance from one another by columns 20; namely, the cutting, or severing roller 10 is journaled at the upper end in the board 21. The lower end of the shaft, or shaft arrangement 19 projects beyond the lower, or underside of the board 22 which underside is facing away from the board 21, and the lower end of the shaft 19 is provided there with a gearwheel 23 for the drive arrangement of this shaft, or shaft arrangement 19 and its associated cutting, or severing roller 10. Between the two boards 21 and 22 there is provided—configured to rotate with the shaft 19—the part, or parts of the cutting, or severing roller 10 that is configured, or embodied by the two format parts 15 and 16, as well as the counter knife 14, which counter knife 14 is configured in the shape of a bar, or the like structure. For this there is fastened, in close proximity with respect to the board 22, on the shaft, or shaft arrangement 19 a circularly shaped carrier element, or carrier member 24 which extends with its axis in a manner that is substantially coincidentally with respect to the axis of the shaft, or shaft arrangement 19 and which carrier member 24 is configured—at its upper surface that faces away from the board 22—with ring-shaped contours, or formations 24.1 which surround the axis of the shaft, or shaft arrangement 19. On the upper side of the carrier element, or carrier member 24 are supported, or bear the counter knife 14, as well as the respectively used format parts 14 and 15 with their lower forehead side 15.1 or, respectively, forehead side 16.1, namely, in such a way that contours, or formations provided in the area of these forehead sides intervene in form-locking manner in the contours, or formations 24.1; and the format parts 15 and 16—that are arranged with their axes in a manner such that these axes extend in substantially axis-coordinated, or axis-aligned manner with the axis of the shaft, or shaft arrangement to 19—are thereby held in such a way so as to substantially alleviate at least radially outwardly active, or directed forces and in form-locking manner at the carrier element, or carrier member 24.

In the region of the upper end of the shaft, or shaft arrangement 19 on this shaft 19 there is provided a clamping and tensioning device 25 by means of which the counter knife 14, as well as also the respectively employed format parts 15 and 16 that are used in each case are retained in a releasable manner at the shaft, or shaft arrangement 19 or, respectively, at the carrier element, or carrier member 24, as well as also the clamping and tensioning device 25 as such, namely, in such a way that the format parts 15 and 16 with their inner surface are clearly distanced away from the shaft, or shaft arrangement 19 so that the cutting, or severing roller 10 practically configures a hollow cylinder with a diminished mass.

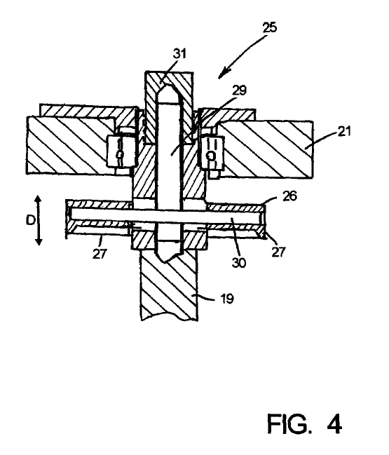

The clamping and tensioning device 25 comprises, as is shown in the embodiment illustrated in FIGS. 3 and 4 a clamping disc 26 which is disposed in axis-coincidental manner with the axis of the shaft 19, with the shaft 19 comprising a hollow shaft at its upper terminus, and the clamping disc 26 can be adjustably shifted by a certain amount of distance in the axial direction of the shaft, or shaft arrangement 19 (compare the double-headed arrow D). The clamping disc 26 which is disposed near the board 21 comprises—at its underside that is facing away from this board 21—an annular projection 27 that concentrically surrounds the axis of the shaft, or shaft arrangement 19, which projection 27 reaches—when the counter knife 14 as well as the format parts 15 and 16 are connected at the shaft 19—into respectively one partial-ring-shaped groove 28 which groove 28 is provided in the region of the upper terminus of the bar-shaped counter knife 14, as well as in the area of the upper edge, or, respectively the upper forehead side 15.2 or, respectively, forehead side 16.2 of the format parts 15 and 16; namely, in the shown embodiment, the groove 28 is positioned interiorly and in offset manner axially downwardly with respect to the upper terminus of the counter knife 14 or, respectively, with respect to the upper forehead side 15.2 and 16.2, so that—when the counter knife 14 and the format parts 15 and 16 are secured by the clamping and tensioning device 25 at the shaft 19—the clamping disc 26 is positioned interiorly and in such a way that it can not be seen at the circumferential surface 11 of the cutting, or severing roller 10. In at least one possible embodiment, in the case of a very compact construction, or configuration the circumferential surface 11 of the cutting, or severing roller 10 can be configured—when considered in the axial direction of the shaft, or shaft arrangement 19—in a rather broad, or wide manner, i.e. also labels 3 with considerable height or, respectively, label material 3.1 with a considerable width can be processed.

Component of the clamping and tensioning device 25 is, furthermore, a pin, or bolt shaped pressure, or pulling anchor 29 that is provided interiorly with respect to the shaft, or shaft arrangement 19 and axis-coincidentally with respect thereto, which anchor 29 is configured to perform a pulling action in axial direction (compare the direction indicated by the double headed arrow D), namely, for the closing and opening of the clamping and tensioning device, or element 25. The pulling, or pressure anchor 29 is connected—by a pin 30 that extends radially with respect to the axis of the shaft, or shaft arrangement 19 and through slits in this shaft, or shaft arrangement (19)—to the clamping disc 26. Furthermore, the pressure anchor 29, at its upper end, reaches into a nut structure 31 that is configured so as to be able to effectuate a threaded connection that can be provided, on the one hand, by a male thread formation and, on the other hand, by an internal, or female thread formation at the upper end of the shaft, or shaft arrangement 19 and in which nut structure 31 the pressure anchor 29 is journaled for rotation in a suitable manner; however, the anchor 29 is provided in such a way that it cannot be shifted in axial direction.

By way of turning of the nut structure 31 in one direction the clamping disc 26 is moved in downward direction by means of the pressure anchor 29 and the counter knife 14, as well as the format parts 15 and 16 are secured in force-locking manner between the clamping disc 26 and the carrier element 24. In order to release the counter knife 14 and the format parts 15 and 16 the nut structure 31 is turned in the opposite direction so that the clamping disc 26, by way of the pressure anchor 29, is raised and the projection, or formation 27 is released from the engagement with the grooves 28. Basically, there also exists the possibility to configure the clamping and tensioning device 25 with a spring arrangement, or springs, for instance, by the fact that the end, or terminus of the pressure anchor 29 which end extends into the nut structure 31 abuts there against a compression spring element, so that the clamping connection of the counter knife 14 and the format parts 15 and 16 also occurs, in addition, under the effect of a spring, or a similar biasing arrangement.

The ring-shaped contours 24.1 in the upper side of the carrier element, or carrier members 24, as well as the suitable contours cooperating with these contours at the lower end of the counter knife 14, as well as in the lower forehead side 15.1 and 16.1 of the format parts 15 and 16, but also the projection 27 and the accompanying groove 28 in the format parts 15 and 16, as well as at the upper end of the counter knife 14 are configured in such a way that upon operatively clamping the counter knife 14, as well as the format parts 15 and 16 are positioned between the carrier element 24 and the clamping disc 26 in precise or general manner with respect to the axis of the shaft, or shaft arrangement 19; or, respectively, these components are centered.

In order so as to supply the vacuum in the vacuum canals 18 of the format parts 15 and 16 there are provided in pertaining manner continuous drillings, or openings in the carrier element, or carrier member 24, namely, in such a way that these drillings allow the pertaining flow in each case into the vacuum distributor canal 18.1. Against the underside of the carrier element, or carrier members 24 that is facing the board 22, there abuts a distributor plate 32 that does not rotate with the shaft, or shaft arrangement 19 which distributor plate 32 comprises a vacuum canal 33 with a large number of vacuum openings which, while being sealed with respect to the outside, are, respectively, positioned to be in operative connection, by way of the openings in the carrier element, or carrier member 24, with the vacuum distributor canals 18.1 of the used format parts 15 and 16. The distributor plate 32 abuts with springs (spring elements 35) against the underside of the carrier element, or carrier member 24.

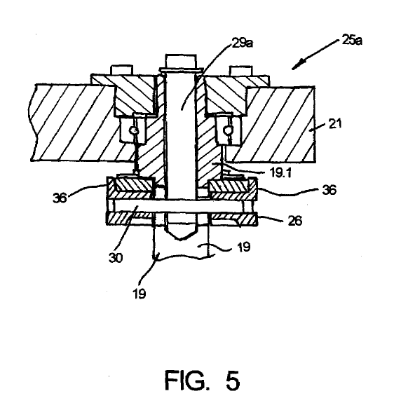

FIG. 5 shows in a representation similar to FIG. 4 as a further embodiment a clamping and tensioning device 25a which differs from the clamping and tensioning device 25 basically by the fact that the clamping force, or, respectively, the clamp-down force by means of which the counter knife 14, as well as the used format parts 15 and 16 are clamped between the upper clamping disc 26 and the lower carrier element, or carrier member 24 is generated by a spring arrangement 36 which is operative between a collar, or step 19.1 of the shaft, or shaft arrangement 19 and the clamping disc 26. A pulling anchor 29a in this embodiment serves for raising of the clamping disc 26, against the force of the spring arrangement 36, namely, for release of the clamping and tensioning device 25a during an exchanging of the format parts 15 and 16.

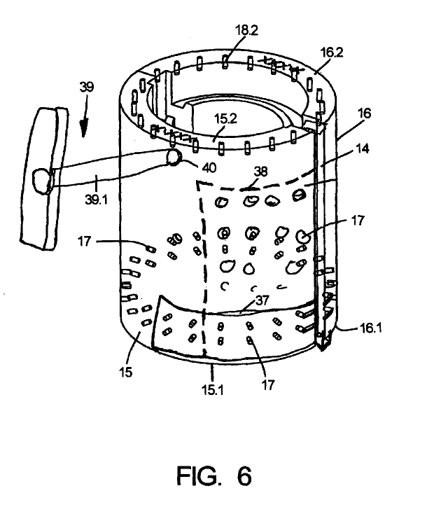

The FIG. 6 shows again both format parts 15 and 16. In this drawing figure the reference numerals 37 and 38 indicate demarcation lines of various regions at the circumferential surface 11 in which (surface areas) can be provided—in the case of format parts that are intended for use with differing labels 3—correspondingly suitable vacuum openings 17.

Furthermore, in FIG. 6 there is shown a handle 39 which can be connected in releasable manner to the format parts 15 and 16; namely, in such a way that this handle extends in one possible embodiment radially, or nearly radially away from the respective format part 15. The installation and removal of the format parts 15 and 16 can essentially be simplified by the handle 39. The releasable connection of the handle 39 is realized by the fact that at the end of the grip, or handle shaft 39.1 there is provided an exterior threading, or male thread formation which can be screwed into an interior threading, or female thread formation 40 in the exterior surface of the respective format part 15 and 16. This interior threading 40 is, of course, provided at those locations which do not have vacuum openings 17.

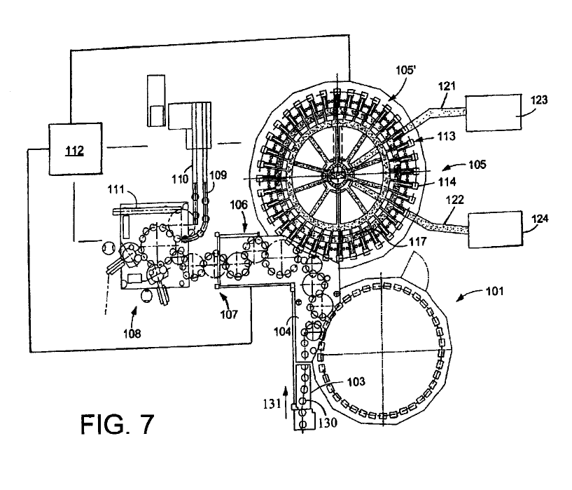

FIG. 7 shows schematically the main components of one possible embodiment example of a system for filling containers, specifically, a beverage bottling plant for filling bottles 130 with at least one liquid beverage, in accordance with at least one possible embodiment, in which system or plant could possibly be utilized at least one aspect, or several aspects, of the embodiments disclosed herein.

FIG. 7 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 7, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 has three output conveyer arrangement: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement or system 112, which could be, for example, computerized control system that monitors and controls the operation of the various stations and mechanisms of the beverage bottling plant.

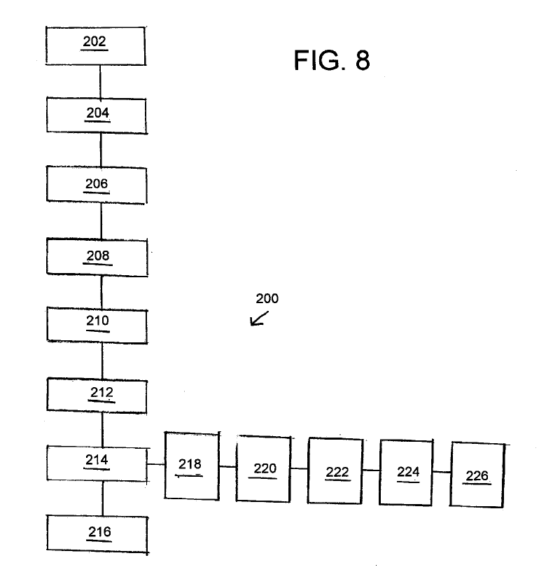

FIG. 8 shows a block diagram of a container filling plant 200. Container supply station 202 supplies containers to conveying apparatus 204. The containers being supplied and conveyed may be bottles, bags, sacks, cans, or any such container as is known in the art. Conveying apparatus 204 may have a linear or rotor configuration and is configured to receive containers from container supply station 202 and convey the containers to container filling station 204. Container filling station 206 may be rotary or linearly arranged and may incorporate a rinsing arrangement. Container filling station 206 is configured to receive empty containers from conveying apparatus 204 and fill containers. Filled containers are then transferred by a conveyer arrangement 208, which can be a linear conveyor or a combination of a linear conveyor and a starwheel.

Container filling machine 206 may have a revolving or rotary design or may have a linear design. Container filling machine 206 may have a plurality of filling positions with a filling device, element, apparatus, or valve. The filling devices may be designed to introduce a predetermined volume or amount of material into the interior of the containers to a predetermined or desired level.

Downstream of the filling station 206, the filled containers are transported to a closing machine 210 by conveyer arrangement 208 that is formed, for example, by one or more linear arrangements or starwheels that transfer filled containers from filling station 206 to closing machine 210.

The container closing arrangement or closing machine 210 may be configured to screw caps onto bottles, seal plastic bags, or close other containers by a means as known in the art for closing such containers. Closing machine 210 may have a rotary or linear configuration. Closed containers are transferred from container closing machine 210 with conveying arrangement 212 to container disposing arrangement 214 for labeling. Conveyer arrangement 212 may be formed, for example, by one or more linear arrangements or starwheels that transfer closed containers from closing station 210 to a labeling machine. Container disposing arrangement 214 may have a linear arrangement or may be rotary, such as a carousel.

A labeling machine may comprise a label material supply 226 which may supply label material in uncut strip form from a roller or may supply label material in the form of precut individual labels. Conveying arrangement 224 is configured to transfer label material from label material supply 226 to cutting station 222 and may have grippers or may transfer label material with vacuum or electrostatic energy.

Cutting station 222 is configured to cut label material into individual labels in an embodiment where uncut labels are transferred from label material supply 226 with conveying arrangement 224. Cutting station 222 may cut labels independently or may cooperate with transfer station 220 to cut labels. In at least one embodiment, cutting station 222 comprises at least one knife that is configured to cooperate with transfer station 220 to cut label material. For example, transfer station 220 may have a drum with an outer cylindrical surface that receives label material in strip form from conveying arrangement 224. The drum may be a vacuum drum and may have at least one anvil in the outer surface thereof configured to cooperate with the at least one knife. As the label material is disposed about the drum, the drum rotates a knife comes into close proximity to the outer surface of the drum at periodic intervals to cut the label material into individual labels. The at least one knife may reciprocate or may revolve about an axis. In the embodiment of the drum having at least one anvil, the at least one knife cooperates with the anvil to effectuate the cut.

In at least one embodiment of filling plant 200, transfer station 222 comprises at least two form parts extending along an axis of rotation and a clamping device comprising a first and a second clamping part configured to hold the at least two form parts in place. The first clamping part cooperates with a one axial end of the at least two form parts and the second clamping part cooperates with the other axial end of the at least two form parts. The clamping parts provide an axially directed clamping force parallel to the axis of the at least two form parts to hold the form parts between the first and second clamping parts.

Transfer station 222 may place containers directly onto containers or may pass cut labels to conveying arrangement 218. Conveying arrangement 218 is configured to transfer individual cut labels to the surface of containers. Conveying arrangement 218 is configured to transfer individual labels from transfer station 220 and onto containers in container disposing station 214 and may have grippers or may transfer label material with vacuum or electrostatic energy.

Conveying arrangement 216 is configured to convey labeled containers from container filling plant 200. Conveying arrangement 216 may have a linear or rotor configuration and is configured to receive labeled containers from container disposing station 214 and convey the containers for further processing or packaging.

The present application was described in the foregoing on the basis of embodiment examples. It will be appreciated that numerous changes, as well as variations are possible, without departing from the basic, or underlying spirit, or thought of the present application.

There is now disclosed a transport roller for labels, which roller can be employed in labeling equipment, or in a labeling arrangement and which roller comprises a circumferential surface that is configured by at least two exchangeable format parts at a shaft, or shaft arrangement that is configured to be rotated, and that is further configured with vacuum openings that are configured to effectuate the fixing of the labels, or an label material that provides pertaining labels; with the format parts being held by an axially directed clamping action, or force between a carrier element, or carrier member at the shaft, or shaft arrangement, and the at least one clamping and tensioning element, or device provided at the shaft, or shaft arrangement.

One feature or aspect of an embodiment is believed at the time if the filing of this patent application to possibly reside broadly in a transport roller for labels 3 for the use in a labeling equipment, or labeling arrangement 1, with a circumferential surface 11 that is configured—at a shaft, or shaft arrangement 19 that is configured to be driven so as to rotate—by at least two interchangeable format parts, or form parts 15, 16 and within this circumferential surface 11 there are provided vacuum openings 17 for the holding, or, respectively, fixing of the labels, or an label material 3.1 that is configured to provide the labels 3, wherein the format parts 15, 16 are held by an axially directed clamping force between one in the shaft, or shaft arrangement 19 provided carrier element, or carrier member 24 and at least one clamping and tensioning device, or element 25 that is provided at the shaft, or shaft arrangement 19.

Another feature or aspect of an embodiment is believed at the time if the filing of this patent application to possibly reside broadly in the transport roller, wherein the transport roller is configured as a cutting or severing roller 10 and that the transport roller comprises at least one in the circumferential surface 11 provided counter knife 14 that is configured to co-act with a knife of a shaft, or shaft arrangement 12, or with a knife on a shaft, or shaft arrangement 12.

Yet another feature or aspect of an embodiment is believed at the time if the filing of this patent application to possibly reside broadly in the transport roller, wherein the counter knife 14 is held by an axially directed clamping force in the shaft, or shaft arrangement 19, or the counter knife 14 is provided least one form part 15, 16.

Still another feature or aspect of an embodiment is believed at the time if the filing of this patent application to possibly reside broadly in the transport roller, wherein the at least one clamping element, or device is configured as a clamping disc 26 which is arranged in axis-coincidental manner with respect to the axis of the shaft, or shaft arrangement 19, or the pertaining axis of rotation of the transport roller 10 and said clamping disc 26 is movable in the direction of this axis of the shaft, or shaft arrangement 19 for the fastening of the form parts 15, 16, as well as for the releasing of the form parts 15, 16.

A further feature or aspect of an embodiment is believed at the time if the filing of this patent application to possibly reside broadly in the transport roller, wherein the exterior surface of the form parts 15, 16 is formed in each case by a partial-cylinder-surface.

Another feature or aspect of an embodiment is believed at the time if the filing of this patent application to possibly reside broadly in the transport roller, wherein the form parts 15, 16 as to their constructive configuration correspond in each case to wall segments of a hollow cylinder.

Yet another feature or aspect of an embodiment is believed at the time if the filing of this patent application to possibly reside broadly in the transport roller, wherein the format parts are configured to operatively intervene, or are configured to operatively extend into one contour, or formation 24.1, at an edge portion 15.1, 16.1 that is provided, in a supporting manner, or bears at the carrier element, or carrier member 24, and in force-locking manner, for the secure intervention, or securing of said format parts 15, 16, at least radially with respect to the axis of the shaft, or shaft arrangement 19, or radially with respect to the axis of rotation of the transport roller 10.

Still another feature or aspect of an embodiment is believed at the time if the filing of this patent application to possibly reside broadly in the transport roller, wherein the contour 24.1 in the carrier element, or carrier member 24 is formed by at least one, the axis of the shaft, or shaft arrangement 19, or the axis of rotation of the transport roller 10 concentrically surrounding ring-shaped deepening, or is formed by a ring-shaped projection that is configured to surround the axis of the shaft, or shaft arrangement 19, or surrounds the axis of rotation of the transport roller 10.

A further feature or aspect of an embodiment is believed at the time if the filing of this patent application to possibly reside broadly in the transport roller, wherein the clamping and tensioning element comprises a clamping disc 26.

Another feature or aspect of an embodiment is believed at the time if the filing of this patent application to possibly reside broadly in the transport roller, wherein the format parts 15, 16 are held in form-locking manner by way of a contour, or the like formation 27 that is constructively configured at the clamping and tensioning element, or device 25.

Yet another feature or aspect of an embodiment is believed at the time if the filing of this patent application to possibly reside broadly in the transport roller, wherein the contour, or the like formation 27 that is configured at the clamping element and tensioning element, or device 25 is formed by at least one projection 27, and/or by at least one recess, or depression.

Still another feature or aspect of an embodiment is believed at the time if the filing of this patent application to possibly reside broadly in the transport roller, wherein the at least one projection 27, and/or the at least one recess, or depression is configured in such a way so as to be surrounding the axis of the shaft, or shaft arrangement 19, or the axis of rotation of the transport roller 10 in the manner of a ring.

A further feature or aspect of an embodiment is believed at the time if the filing of this patent application to possibly reside broadly in the transport roller, wherein the operative profile of the clamping and tensioning device 25 is provided by several projections, and/or recesses, or depressions which are configured so as to extend, in distributed manner, around the axis of the shaft, or shaft arrangement 19, or around the axis of rotation of the transport roller.

Another feature or aspect of an embodiment is believed at the time if the filing of this patent application to possibly reside broadly in the transport roller, wherein the clamping and tensioning element, or device 25 can be pressed, by means of at least one pressure component 29 that is configured to be moved—in the direction of the shaft, or shaft arrangement 19, for clamping of the format parts 15, 16—against these format parts.

Yet another feature or aspect of an embodiment is believed at the time if the filing of this patent application to possibly reside broadly in the transport roller, wherein the pressure component 29 is formed by a pin structure, or bolt structure.

Still another feature or aspect of an embodiment is believed at the time if the filing of this patent application to possibly reside broadly in the transport roller, wherein the format parts 15, 16 are configured to be clamped between the carrier element, or carrier member 24 and the clamping and tensioning element, or device 25 by means of a threaded formation 31 that is configured to operatively impact on said clamping and tensioning element, or device 25.

A further feature or aspect of an embodiment is believed at the time if the filing of this patent application to possibly reside broadly in the transport roller, wherein the threaded formation, or element 31 is in one possible embodiment configured as a nut 31, or as a bolt that is configured to impact, or bear upon the clamping and tensioning device, or element 25, by way of the pressure component 29, and that is further configured to be in operative interaction with a threaded formation at the shaft, or shaft arrangement 19.

Another feature or aspect of an embodiment is believed at the time if the filing of this patent application to possibly reside broadly in the transport roller, comprising a spring arrangement 36 that is configured to operatively impact upon the clamping and tensioning element, or device 25 for operatively securing, or clamping of the format parts 15, 16 between the carrier element, or carrier member 24 and the clamping and tensioning element, or device 25.

Yet another feature or aspect of an embodiment is believed at the time if the filing of this patent application to possibly reside broadly in the transport roller, comprising means, for instance, a pulling anchor 29a for moving of the clamping and tensioning element, or device 25 against the action of the spring arrangement 36 for loosening, or, respectively, removal of the format parts 15, 16.

Still another feature or aspect of an embodiment is believed at the time if the filing of this patent application to possibly reside broadly in the transport roller, wherein in the format elements 15 there are configured vacuum canals 18 that are operatively connectable to said vacuum openings 17, and said vacuum canals 18 are connectable, by means of a rotating connection 32, to a source of under pressure, or a source of a vacuum.

A further feature or aspect of an embodiment is believed at the time if the filing of this patent application to possibly reside broadly in the transport roller, wherein the rotating connection comprises a distributor plate 32 with at least one vacuum canal 33 and several openings 34 are provided at this canal 33 and that the distributor plate 32—which does not rotate with the shaft, or shaft arrangement 19—with its vacuum canal openings 34 under configuration of a rotating connection, abuts against a surface which is configured to provide passages to the vacuum canals 18 that are provided in the format parts 15, 16.

Another feature or aspect of an embodiment is believed at the time if the filing of this patent application to possibly reside broadly in the transport roller, wherein the vacuum canals 18 are open at the surface 15.1, 16.1 of the format parts 15, 16 which surface abuts, or is positioned to be in contact with the carrier element, or carrier member 24, are configured to be open, or are configured to permit the pertaining flow into a distributor canal 18.1 provided there, and that in the carrier element, or carrier member 24 there are provided passages which are in communication with the vacuum canal openings 34 of the distributor element 32 that does not rotate with the transport roller.

Yet another feature or aspect of an embodiment is believed at the time if the filing of this patent application to possibly reside broadly in the transport roller, wherein the format parts 15, 16 with their inner surfaces are positioned at a distance from the shaft, or shaft arrangement 19.

One another feature or aspect of an embodiment is believed at the time if the filing of this patent application to possibly reside broadly in a labeling machine for equipping of containers with labels made from an endless label strand, or band, wherein this machine is equipped with a transport roller according to the present application.

One feature or aspect of an embodiment is believed at the time of the filing of this patent application to possibly reside broadly a labeling machine in a bottling plant, the bottling plant comprising: a first conveyor arrangement being configured and disposed to convey empty bottles to be filled; a bottle filling machine being configured and disposed to receive empty bottles from the first conveyor arrangement and fill bottles; a second conveyor arrangement being configured and disposed to receive filled bottles from the bottle filling machine and convey filled bottles to be closed; a bottle closing machine configured to receive filled bottles from the second conveyor arrangement and close filled bottles; a third conveyor arrangement being configured and disposed to receive closed bottles from the bottle closing machine and convey closed bottles to be labeled; a labeling machine configured to receive closed bottles from the third conveyor arrangement and place labels onto bottles, the labeling machine comprising: a label supply roller configured to supply a roll of uncut labels in strip form; a feeding arrangement configured to receive uncut labels in strip form from the label supply roller and supply uncut labels in strip form; a cutting station configured to receive uncut labels in strip form from the feeding arrangement and cut uncut labels into individual labels, the cutting station comprising: a vacuum drum comprising: at least two semi-cylindrical form parts extending along an axis of rotation of the vacuum drum, each of the at least two semi-cylindrical form parts comprising a plurality of vacuum openings in an outer circumferential surface thereof; the vacuum openings being configured to be in flow communication with a vacuum source; at least one anvil extending parallel to the axis of rotation of the vacuum drum disposed between the at least two semi-cylindrical form parts; the at least one anvil comprising an outer surface at least substantially adjacent with the outer circumferential surfaces of the at least two semi-cylindrical form parts; an annular groove in an upper axial end surface of the vacuum drum, the annular groove being recessed concentrically with the axis of rotation of the vacuum drum; a clamping device comprising a first, upper, and a second, lower, clamping part configured to hold the at least two semi-cylindrical form parts and the at least one anvil together with an axially directed clamping force parallel to the axis of rotation of the vacuum drum; the first, upper, clamping part comprising a portion configured to cooperate within the upper axial groove to form the vacuum drum with the application of the axially directed clamping force; and the vacuum drum being configured to dispose label material substantially throughout the outer surfaces of the at least two semi-cylindrical form parts; the cutting station further comprising: a cutting arrangement comprising: a cylinder with a rotational axis substantially parallel with the axis of rotation of the vacuum drum; at least one knife axially extending away from the rotational axis of the cylinder and having an axial length substantially equivalent to the axial length of the at least one anvil; and the at least knife configured to cooperate with the at least one anvil to cut uncut labels in strip form into individual labels; the labeling machine further comprising: a transfer roller configured to transfer cut labels from the outer surface of the vacuum drum to bottles; and a carousel configured to receive filled and closed bottles from the third conveyor arrangement and dispose bottles to receive cut labels from the transfer roller.

Another feature or aspect of an embodiment is believed at the time of the filing of this patent application to possibly reside broadly in a bottling plant wherein the upper and the lower clamping parts each comprise a disc shaped portion configured to cooperate with axial ends of the vacuum drum; the upper clamping part being configured to move away from the vacuum drum axially along the axis of rotation of the vacuum drum to permit removal of the at least two semi-cylindrical form parts and the anvil from the vacuum drum; and the upper clamping part being configured to move toward the vacuum drum axially along the axis of rotation of the vacuum drum to provide an axial directed clamping force parallel to the axis of rotation of the vacuum drum and hold the at least two semi-cylindrical form parts and the anvil in place between the upper and the lower clamping parts.

Yet another feature or aspect of an embodiment is believed at the time of the filing of this patent application to possibly reside broadly in a bottling plant wherein: the vacuum drum comprises a groove concentric with the axis of rotation of the vacuum drum in a lower axial surface of the vacuum drum; the disc shaped portion of the lower and the upper clamping parts each comprise a projection extending toward the vacuum drum, each projection being concentric with the axes of rotation of the upper and the lower clamping part; and each of the projections being configured to cooperate with each of the grooves in the axial surfaces of the vacuum drum.

Still another feature or aspect of an embodiment is believed at the time of the filing of this patent application to possibly reside broadly in a bottling plant wherein the cutting station further comprises: a first journal configured to dispose and permit rotation of the upper clamping part; a second journal configured to dispose and permit rotation of the lower clamping part; the first journal comprising a threaded formation centrally oriented with the axis of rotation of the vacuum drum; a bolt or nut configured to threadingly engage the threaded formation of the first journal and provide a pulling force and an axial directed clamping force; a spring element configured to transfer a pulling force and an axial directed clamping force produced by the bolt or nut; an anchor configured to transfer a pulling force and an axial directed clamping force from the spring element; and a pin extending radially in the upper clamping part configured to transfer an axial directed force from the anchor to the upper clamping part providing an axially directed clamping force for holding the at least one anvil and the at least two semi-cylindrical parts together and an axial directed pulling force enabling the removal of the at least two semi-cylindrical form parts and the anvil from the vacuum drum.

A further feature or aspect of an embodiment is believed at the time of the filing of this patent application to possibly reside broadly in a labeling machine in a container filling plant, the container filling plant comprising: a first conveyor arrangement being configured and disposed to convey empty containers to be filled; a container filling machine being configured and disposed to receive empty containers from the first conveyor arrangement and fill containers; a second conveyor arrangement being configured and disposed to receive filled containers from the container filling machine and convey filled containers to be closed; a container closing machine configured to receive filled containers from the second conveyor arrangement and close filled containers; a third conveyor arrangement being configured and disposed to receive closed containers from the container closing machine and convey closed containers to be labeled; a labeling machine configured to receive closed containers from the third conveyor arrangement and place labels onto containers, the labeling machine comprising: a label supply arrangement configured to supply uncut labels in strip form; a cutting station configured to receive uncut labels in strip form from the label supply arrangement and cut uncut labels into individual labels, the cutting station comprising: a vacuum drum comprising: at least two partial cylindrical form parts extending along an axis of rotation of the vacuum drum, each of the at least two partial cylindrical form parts comprising a plurality of vacuum openings in an outer circumferential surface thereof; the vacuum openings being configured to be in flow communication with a vacuum source; and a clamping device comprising a first and a second clamping part configured to hold the at least two partial cylindrical form parts in place between the first and a second clamping parts with an axially directed clamping force parallel to the axis of rotation of the vacuum drum; the cutting station further comprising: a cutting arrangement comprising: at least one knife extending substantially parallel with the axis of rotation of the vacuum drum; the at least one knife being configured to rotate about an axis substantially parallel to the axis of rotation of the vacuum drum; and the at least knife configured to cooperate with the vacuum drum to cut uncut labels in strip form into individual labels; the labeling machine further comprising: a transfer roller configured to transfer cut labels from the outer surface of the vacuum drum to containers; and a carousel configured to receive filled and closed containers from the third conveyor arrangement and dispose containers to receive cut labels from the transfer roller.

Another feature or aspect of an embodiment is believed at the time of the filing of this patent application to possibly reside broadly in a labeling machine wherein: the first and the second clamping parts each comprise a disc shaped portion configured to cooperate with axial ends of the vacuum drum; the first clamping part being configured to move away from the vacuum drum axially along the axis of rotation of the vacuum drum to permit removal of the at least two partial cylindrical form parts and the anvil from the vacuum drum; and the first clamping part being configured to move toward the vacuum drum axially along the axis of rotation of the vacuum drum to provide an axial directed clamping force parallel to the axis of rotation of the vacuum drum and hold the at least two partial cylindrical form parts and the anvil in place between the first and a second clamping parts.

Yet another feature or aspect of an embodiment is believed at the time of the filing of this patent application to possibly reside broadly in a labeling machine comprising: a groove concentric with the axis of rotation of the vacuum drum in each axial end of the vacuum drum; a projection extending from each of the disc shaped portions of the first and the second clamping parts; each of the projections extending toward the vacuum drum and being concentric with the axes of rotation of the first and the second clamping parts; and each of the projections being configured to cooperate with each of the grooves in the axial ends of the vacuum drum.

Still another feature or aspect of an embodiment is believed at the time of the filing of this patent application to possibly reside broadly in a labeling machine of comprising: a first journal configured to dispose and permit rotation of the first clamping part; a second journal configured to dispose and permit rotation of the second clamping part; the first journal comprising a threaded formation centrally oriented with the axis of rotation of the vacuum drum; and a bolt or nut configured to threadingly engage the threaded formation of the first journal and provide a pulling force and an axial directed clamping force to the first clamping part.

A further feature or aspect of an embodiment is believed at the time of the filing of this patent application to possibly reside broadly in a labeling machine comprising an anchor between the bolt or nut and the first clamping part; the anchor being configured to transfer an axial directed clamping force from the bolt or nut to the first clamping part; and the anchor being configured to transfer an axial directed pulling force from the bolt or nut to the first clamping part enabling the removal of the first and the second cylindrical form parts and the anvil from the vacuum drum.

Another feature or aspect of an embodiment is believed at the time of the filing of this patent application to possibly reside broadly in a labeling machine comprising: a spring element between the bolt or nut and the anchor; and a pin extending radially in the first clamping part being configured to transfer an axial directed force from the anchor to the first clamping part.

Yet another feature or aspect of an embodiment is believed at the time of the filing of this patent application to possibly reside broadly in a labeling machine comprising: a label supply apparatus configured to supply label material; a substantially cylindrical transfer drum configured to receive and transfer labels, the transfer drum comprising: a centrally oriented axis of rotation; at least two partial cylindrical form parts extending along the axis of rotation of the transfer drum; the at least two partial cylindrical form parts being disposed together to form the substantially cylindrical surface of the transfer drum; a clamping device comprising a first and second clamping part; and the clamping device being configured to hold the at least two partial cylindrical form parts in place between the first and the second clamping parts with an axially directed clamping force parallel to the axis of rotation of the transfer drum; the labeling machine further comprising: a transfer arrangement configured to transfer labels from the outer surface of the transfer drum to items to be labeled.

Another feature or aspect of an embodiment is believed at the time of the filing of this patent application to possibly reside broadly in a labeling machine comprising: at least one anvil extending parallel to the axis of rotation of the transfer drum and disposed between the at least two partial cylindrical form parts, the at least one anvil being configured to be held in place with the clamping device between the first and the second clamping parts with an axially directed clamping force parallel to the axis of rotation of the transfer drum.

Yet another feature or aspect of an embodiment is believed at the time of the filing of this patent application to possibly reside broadly in a labeling machine comprising a cutting arrangement, the cutting arrangement comprising: at least one knife extending substantially parallel with the axis of rotation of the transfer drum; and the at least knife configured to cooperate with the at least one anvil to cut uncut labels into individual labels.

Still another feature or aspect of an embodiment is believed at the time of the filing of this patent application to possibly reside broadly in a labeling machine wherein: the first and the second clamping parts each comprise a disc shaped portion configured to cooperate with axial ends of the transfer drum; the first clamping part being configured to move away from the transfer drum axially along the axis of rotation of the transfer drum to permit removal of the at least two partial cylindrical form parts and the anvil from the transfer drum; and the first clamping part being configured to move toward the transfer drum axially along the axis of rotation of the transfer drum to provide an axial directed clamping force parallel to the axis of rotation of the transfer drum and hold the at least two partial cylindrical form parts and the anvil in place between the first and a second clamping parts.

A further feature or aspect of an embodiment is believed at the time of the filing of this patent application to possibly reside broadly in a labeling machine comprising: a groove concentric with the axis of rotation of the transfer drum in each axial end of the transfer drum; a projection extending from each of the disc shaped portions of the first and the second clamping parts; each of the projections extending toward the transfer drum and being concentric with the axes of rotation of the first and the second clamping parts; and each of the projections being configured to cooperate with each of the grooves in the axial ends of the transfer drum.

Another feature or aspect of an embodiment is believed at the time of the filing of this patent application to possibly reside broadly a labeling machine comprising: a first journal configured to dispose and permit rotation of the first clamping part; a second journal configured to dispose and permit rotation of the second clamping part; the first journal comprising a threaded formation centrally oriented with the axis of rotation of the transfer drum; and a bolt or nut configured to threadingly engage the threaded formation of the first journal and provide a pulling force and an axial directed clamping force to the first clamping part.

Yet another feature or aspect of an embodiment is believed at the time of the filing of this patent application to possibly reside broadly in a labeling machine comprising an anchor between the bolt or nut and the first clamping part; the anchor being configured to transfer an axial directed clamping force from the bolt or nut to the first clamping part; and the anchor being configured to transfer an axial directed pulling force from the bolt or nut to the first clamping part enabling the removal of the first and the second cylindrical form parts and the anvil from the transfer drum.

Another feature or aspect of an embodiment is believed at the time of the filing of this patent application to possibly reside broadly a labeling machine comprising: a spring element between the bolt or nut and the anchor; and a pin extending radially in the first clamping part being configured to transfer an axial directed force from the anchor to the first clamping part.

Yet another feature or aspect of an embodiment is believed at the time of the filing of this patent application to possibly reside broadly in a labeling machine wherein each of the at least two partial cylindrical form parts comprise a plurality of vacuum openings in an outer circumferential surface thereof, the vacuum openings being configured to be in flow communication with a vacuum source.

Still another feature or aspect of an embodiment is believed at the time of the filing of this patent application to possibly reside broadly in a labeling machine comprising: a label supply apparatus configured to supply uncut labels in strip form; and the transfer drum being configured to receive uncut labels in strip form from the label supply apparatus, cut uncut labels into individual labels, and transfer cut labels.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of container filling plants that may possibly be utilized or adapted for use in at least one possible embodiment may possibly be found in the following U.S. Pat. Nos. 4,911,285; 4,944,830; 4,950,350; 4,976,803; 4,981,547; 5,004,518; 5,017,261; 5,062,917; 5,062,918; 5,075,123; 5,078,826; 5,087,317; 5,110,402; 5,129,984; 5,167,755; 5,174,851; 5,185,053; 5,217,538; 5,227,005; 5,413,153; 5,558,138; 5,634,500; 5,713,403; 6,276,113; 6,213,169; 6,189,578; 6,192,946; 6,374,575; 6,365,054; 6,619,016; 6,474,368; 6,494,238; 6,470,922; and 6,463,964.

Some examples of labeling machines that may possibly be utilized or adapted for use in at least one possible embodiment may possibly be found in the following U.S. Pat. No. 6,634,400, entitled “Labeling machine;” No. 6,561,246, entitled “Labeling machine capable of precise attachment of a label to different sizes of containers;” No. 6,550,512, entitled “Labeling machine capable of preventing erroneous attachment of labels on containers;” No. 6,543,514, entitled “In-line continuous feed sleeve labeling machine and method;” No. 6,378,587, entitled “Cylindrical container labeling machine;” No. 6,328,086, entitled “Labeling machine;” No. 6,315,021, entitled “Labeling machine;” No. 6,263,940, entitled “In-line continuous feed sleeve labeling machine and method;” No. 6,199,614, entitled “High speed labeling machine having a constant tension driving system;” No. 6,167,935, entitled “Labeling machine; No. 6,066,223, entitled “Labeling machine and method;” No. 6,050,319, entitled “Non-round container labeling machine and method;” No. 6,045,616, entitled “Adhesive station and labeling machine;” No. 7,065,938, entitled “Beverage Bottling Plant for Filling Bottles With a Liquid Beverage Filling Material, and a Container Filling Plant Container Information Adding Station, Such as, a Labeling Station Having a Gripper Arrangement, Configured to Add Information to Containers, Such as, Bottles and Cans;” No. 7,182,115, entitled “Beverage Bottling Plant for Filling Bottles With a Liquid Beverage Filling Material Having a Container Filling Plant Container Information Adding Station, such as, a Labeling Station, Configured to Add Information to Containers, Such as, Bottles and Cans, and Modules for Labeling Stations and a Bottling Plant having a Mobile Module Carrier;” No. 7,269,930, entitled “Beverage Bottling Plant for Filling Bottles With a Liquid Beverage Filling Material Having a Device for Labeling of Containers with Continuous Feeding of Labels, Even Upon Some Label Supply Arrangements Being Emptied of Labels;” and No. 7,404,275, entitled “Labeling Machine for Beverage Bottling Plant.”

Some examples of label grippers that may possibly be utilized or adapted for use in at least one possible embodiment may possibly be found in the following patents and publications: GB 760,628, entitled “Automatic Labeling Machines;” GB 1,322,926, entitled “Improvements in or Relating to Labeling Machines;” GB 1,348,612, entitled, “Labeling Device;” GB 1,398,886, entitled “Improvements in or Relating to Labeling Apparatus;” and EPO 0 703 150 A1, entitled “A Labeling Machine, In Particular for the Application of a Seal Label to a Container.”

All of the patents, patent applications or patent publications, which were cited in the International Search Report dated Nov. 15, 2007, and/or cited elsewhere are hereby incorporated by reference as if set forth in their entirety herein as follows: U.S. Pat. No. 6,883,576, having the title “QUICK CHANGE ROLL-FED HIGH SPEED LABELING SYSTEM AND METHODS FOR USING SAME,” published on Apr. 26, 2005; EP 0990588, having the title “DEVICE FOR CUTTING FROM A WEB ELEMENTS FOR LAMINATING,” published on Apr. 5, 2000; and WO 2007/110199, having the following English translation of the German title “VACUUM DRUM AND LABELING MACHINE COMPRISING SUCH A DRUM, FOR ATTACHING WRAPAROUND LABELS TO BOTTLES OR THE LIKE CONTAINERS,” published on Oct. 4, 2007.

All of the patents, patent applications or patent publications, which were cited in the German Office Action dated Apr. 18, 2008, and/or cited elsewhere are hereby incorporated by reference as if set forth in their entirety herein as follows: DE 1196058, having the following English translation of the German title “ADJUSTABLE ANVIL FOR CUTTING WINDOW APERTURES AND LIKE OPENINGS IN BLANKS,” published on Jul. 1, 1965.

The patents, patent applications, and patent publication listed above, beginning on line 1114 on page 54 in the paragraph with the phrase: “Some examples of container filling plants . . . ” and ending on line 1183 on page 57 in the paragraph with the phrase: “ . . . published on Jul. 1, 1965” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 035 802.3, filed on Aug. 1, 2006, having inventors Lutz DECKERT and Oliver KRESS, and DE-OS 10 2006 035 802.3 and DE-PS 10 2006 035 802.3, and International Application No. PCT/EP2007/006657, filed on Jul. 27, 2007, having WIPO Publication No. WO 2008/014930 and inventors Lutz DECKERT and Oliver KRESS, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/006657 and German Patent Application 10 2006 035 802.3 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/006657 and DE 10 2006 035 802.3 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Labeling equipment, or labeling arrangement
2 Container
3 Label
3.1 Label material
4 Roller
5 Cutting, or severing station
6 Labeling drum
7 Rotor
8, 9 Conveyor roller
10 Cutting, or severing roller
11 Circumferential surface of the cutting, or severing roller 10
12 Knife shaft, or shaft arrangement
13 Knife
14 Counter knife
15, 16 Format parts
17 Vacuum opening
18 Vacuum canal
18.1 Distributor canal
18.2 Pin
19 Shaft, or shaft arrangement
19.1 Collar, or step at the upper portion, or terminus of the shaft, or shaft arrangement
20 Column, or distance holder
21, 22 Board
23 Gearwheel
24 Circular-cylindrical carrier element, carrier member
24.1 Ring, or annular contour, or formation
25, 25a Clamping and tensioning device, or element
26 Clamping disc
27 Ring-shaped projection, or ring contour, or formation
28 Groove in counter knife 14 as well as format parts 15 and 16
29, 29a Anchor
30 Pin
31 Nut
32 Distributor plate
33 Vacuum canal in distributor plate 32
34 Slit-shaped openings of the distributor canal 33
35 Spring
36 Spring arrangement
37, 38 Boundary lines
39 Handle, or grip
39.1 Grip shaft
40 Interiorly threaded hole
A, B, C Rotation directions
D Axial movement of the clamping disc 26 of the clamping and tensioning device 25, or 25a

What is claimed is:

1. A labeling machine in a bottling plant, said bottling plant comprising:
a first conveyor arrangement being configured and disposed to convey empty bottles to be filled;
a bottle filling machine being configured and disposed to receive empty bottles from said first conveyor arrangement and fill bottles;
a second conveyor arrangement being configured and disposed to receive filled bottles from said bottle filling machine and convey filled bottles to be closed;
a bottle closing machine configured to receive filled bottles from said second conveyor arrangement and close filled bottles;
a third conveyor arrangement being configured and disposed to receive closed bottles from said bottle closing machine and convey closed bottles to be labeled;
a labeling machine configured to receive closed bottles from said third conveyor arrangement and place labels onto bottles, said labeling machine comprising:
a label supply roller configured to supply a roll of uncut labels in strip form;
a feeding arrangement configured to receive uncut labels in strip form from said label supply roller and supply uncut labels in strip form;
a cutting station configured to receive uncut labels in strip form from said feeding arrangement and cut uncut labels into individual labels, said cutting station comprising:
a vacuum drum comprising:
at least two semi-cylindrical form parts extending along an axis of rotation of said vacuum drum, each of said at least two semi-cylindrical form parts comprising a plurality of vacuum openings in an outer circumferential surface thereof;
said vacuum openings being configured to be in flow communication with a vacuum source;
at least one anvil extending parallel to the axis of rotation of said vacuum drum disposed between said at least two semi-cylindrical form parts;
said at least one anvil comprising an outer surface at least substantially adjacent with said outer circumferential surfaces of said at least two semi-cylindrical form parts;
an annular groove in an upper axial end surface of said vacuum drum, said annular groove being recessed concentrically with said axis of rotation of said vacuum drum;
a clamping device comprising a first, upper, and a second, lower, clamping part configured to hold said at least two semi-cylindrical form parts and said at least one anvil together with an axially directed clamping force parallel to the axis of rotation of said vacuum drum;
said first, upper, clamping part comprising a portion configured to cooperate within said upper axial groove to form said vacuum drum with the application of the axially directed clamping force; and
said vacuum drum being configured to dispose label material substantially throughout said outer surfaces of said at least two semi-cylindrical form parts;
said cutting station further comprising:
a cutting arrangement comprising:
a cylinder with a rotational axis substantially parallel with said axis of rotation of said vacuum drum;
at least one knife axially extending away from said rotational axis of said cylinder and having an axial length substantially equivalent to the axial length of said at least one anvil; and
said at least knife configured to cooperate with said at least one anvil to cut uncut labels in strip form into individual labels;
said labeling machine further comprising:
a transfer roller configured to transfer cut labels from the outer surface of said vacuum drum to bottles; and
a carousel configured to receive filled and closed bottles from said third conveyor arrangement and dispose bottles to receive cut labels from said transfer roller.

2. The bottling plant of claim 1 wherein:
said upper and said lower clamping parts each comprise a disc shaped portion configured to cooperate with axial ends of said vacuum drum;
said upper clamping part being configured to move away from said vacuum drum axially along the axis of rotation of said vacuum drum to permit removal of said at least two semi-cylindrical form parts and said anvil from said vacuum drum; and
said upper clamping part being configured to move toward said vacuum drum axially along the axis of rotation of said vacuum drum to provide an axial directed clamping force parallel to the axis of rotation of said vacuum drum and hold said at least two semi-cylindrical form parts and said anvil in place between said upper and said lower clamping parts.

3. The bottling plant of claim 2 wherein:
said vacuum drum comprises a groove concentric with the axis of rotation of said vacuum drum in a lower axial surface of said vacuum drum;
said disc shaped portion of said lower and said upper clamping parts each comprise a projection extending toward said vacuum drum, each projection being concentric with the axes of rotation of said upper and said lower clamping part; and
each of said projections being configured to cooperate with each of said grooves in the axial surfaces of said vacuum drum.

4. The bottling plant of claim 3 wherein said cutting station further comprises:
a first journal configured to dispose and permit rotation of said upper clamping part;
a second journal configured to dispose and permit rotation of said lower clamping part;
said first journal comprising a threaded formation centrally oriented with said axis of rotation of said vacuum drum;
a bolt or nut configured to threadingly engage said threaded formation of said first journal and provide a pulling force and an axial directed clamping force;
a spring element configured to transfer a pulling force and an axial directed clamping force produced by said bolt or nut;
an anchor configured to transfer a pulling force and an axial directed clamping force from said spring element; and
a pin extending radially in said upper clamping part configured to transfer an axial directed force from said anchor to said upper clamping part providing an axially directed clamping force for holding said at least one anvil and said at least two semi-cylindrical parts together and an axial directed pulling force enabling the removal of said at least two semi-cylindrical form parts and said anvil from said vacuum drum.

5. A labeling machine in a container filling plant, said container filling plant comprising:
a first conveyor arrangement being configured and disposed to convey empty containers to be filled;
a container filling machine being configured and disposed to receive empty containers from said first conveyor arrangement and fill containers;
a second conveyor arrangement being configured and disposed to receive filled containers from said container filling machine and convey filled containers to be closed;
a container closing machine configured to receive filled containers from said second conveyor arrangement and close filled containers;
a third conveyor arrangement being configured and disposed to receive closed containers from said container closing machine and convey closed containers to be labeled;
a labeling machine configured to receive closed containers from said third conveyor arrangement and place labels onto containers, said labeling machine comprising:
a label supply arrangement configured to supply uncut labels in strip form;
a cutting station configured to receive uncut labels in strip form from said label supply arrangement and cut uncut labels into individual labels, said cutting station comprising:
a vacuum drum comprising:
at least two partial cylindrical form parts extending along an axis of rotation of said vacuum drum, each of said at least two partial cylindrical form parts comprising a plurality of vacuum openings in an outer circumferential surface thereof;
said vacuum openings being configured to be in flow communication with a vacuum source; and
a clamping device comprising a first and a second clamping part configured to hold said at least two partial cylindrical form parts in place between said first and a second clamping parts with an axially directed clamping force parallel to the axis of rotation of said vacuum drum;
said cutting station further comprising:
a cutting arrangement comprising:
at least one knife extending substantially parallel with said axis of rotation of said vacuum drum;
said at least one knife being configured to rotate about an axis substantially parallel to said axis of rotation of said vacuum drum; and
said at least knife configured to cooperate with said vacuum drum to cut uncut labels in strip form into individual labels;
said labeling machine further comprising:
a transfer roller configured to transfer cut labels from the outer surface of said vacuum drum to containers; and
a carousel configured to receive filled and closed containers from said third conveyor arrangement and dispose containers to receive cut labels from said transfer roller.

6. The labeling machine of claim 5 wherein:
said first and said second clamping parts each comprise a disc shaped portion configured to cooperate with axial ends of said vacuum drum;
said first clamping part being configured to move away from said vacuum drum axially along the axis of rotation of said vacuum drum to permit removal of said at least two partial cylindrical form parts and said anvil from said vacuum drum; and
said first clamping part being configured to move toward said vacuum drum axially along the axis of rotation of said vacuum drum to provide an axial directed clamping force parallel to the axis of rotation of said vacuum drum and hold said at least two partial cylindrical form parts and said anvil in place between said first and a second clamping parts.

7. The labeling machine of claim 6 further comprising:
a groove concentric with the axis of rotation of said vacuum drum in each axial end of said vacuum drum;
a projection extending from each of said disc shaped portions of said first and said second clamping parts;
each of said projections extending toward said vacuum drum and being concentric with the axes of rotation of said first and said second clamping parts; and
each of said projections being configured to cooperate with each of said grooves in the axial ends of said vacuum drum.

8. The labeling machine of claim 7 further comprising:
a first journal configured to dispose and permit rotation of said first clamping part;
a second journal configured to dispose and permit rotation of said second clamping part;
said first journal comprising a threaded formation centrally oriented with said axis of rotation of said vacuum drum; and
a bolt or nut configured to threadingly engage said threaded formation of said first journal and provide a pulling force and an axial directed clamping force to said first clamping part.

9. The labeling machine of claim 8 further comprising an anchor between said bolt or nut and said first clamping part;
said anchor being configured to transfer an axial directed clamping force from said bolt or nut to said first clamping part; and
said anchor being configured to transfer an axial directed pulling force from said bolt or nut to said first clamping part enabling the removal of said first and said second cylindrical form parts and said anvil from said vacuum drum.

10. The labeling machine of claim 9 further comprising:
a spring element between said bolt or nut and said anchor; and
a pin extending radially in said first clamping part being configured to transfer an axial directed force from said anchor to said first clamping part.

11. A labeling machine comprising:
a label supply apparatus configured to supply label material;
a substantially cylindrical transfer drum configured to receive and transfer labels, said transfer drum comprising:
a centrally oriented axis of rotation;
at least two partial cylindrical form parts extending along the axis of rotation of said transfer drum;
said at least two partial cylindrical form parts being disposed together to form said substantially cylindrical surface of said transfer drum;
a clamping device comprising a first and second clamping part; and
said clamping device being configured to hold said at least two partial cylindrical form parts in place between said first and said second clamping parts with an axially directed clamping force parallel to the axis of rotation of said transfer drum;
said labeling machine further comprising:
a transfer arrangement configured to transfer labels from the outer surface of said transfer drum to items to be labeled.

12. The labeling machine of claim 11 further comprising:
at least one anvil extending parallel to the axis of rotation of said transfer drum and disposed between said at least two partial cylindrical form parts, said at least one anvil being configured to be held in place with said clamping device between said first and said second clamping parts with an axially directed clamping force parallel to the axis of rotation of said transfer drum.

13. The labeling machine of claim 12 further comprising a cutting arrangement, said cutting arrangement comprising:
at least one knife extending substantially parallel with the axis of rotation of said transfer drum; and
said at least knife configured to cooperate with said at least one anvil to cut uncut labels into individual labels.

14. The labeling machine of claim 13 wherein:
said first and said second clamping parts each comprise a disc shaped portion configured to cooperate with axial ends of said transfer drum;
said first clamping part being configured to move away from said transfer drum axially along the axis of rotation of said transfer drum to permit removal of said at least two partial cylindrical form parts and said anvil from said transfer drum; and
said first clamping part being configured to move toward said transfer drum axially along the axis of rotation of said transfer drum to provide an axial directed clamping force parallel to the axis of rotation of said transfer drum and hold said at least two partial cylindrical form parts and said anvil in place between said first and a second clamping parts.

15. The labeling machine of claim 14 further comprising:
a groove concentric with the axis of rotation of said transfer drum in each axial end of said transfer drum;
a projection extending from each of said disc shaped portions of said first and said second clamping parts;
each of said projections extending toward said transfer drum and being concentric with the axes of rotation of said first and said second clamping parts; and
each of said projections being configured to cooperate with each of said grooves in the axial ends of said transfer drum.

16. The labeling machine of claim 15 further comprising:
a first journal configured to dispose and permit rotation of said first clamping part;
a second journal configured to dispose and permit rotation of said second clamping part;
said first journal comprising a threaded formation centrally oriented with said axis of rotation of said transfer drum; and
a bolt or nut configured to threadingly engage said threaded formation of said first journal and provide a pulling force and an axial directed clamping force to said first clamping part.

17. The labeling machine of claim 16 further comprising an anchor between said bolt or nut and said first clamping part;
said anchor being configured to transfer an axial directed clamping force from said bolt or nut to said first clamping part; and
said anchor being configured to transfer an axial directed pulling force from said bolt or nut to said first clamping part enabling the removal of said first and said second cylindrical form parts and said anvil from said transfer drum.

18. The labeling machine of claim 17 further comprising:
a spring element between said bolt or nut and said anchor; and
a pin extending radially in said first clamping part being configured to transfer an axial directed force from said anchor to said first clamping part.

19. The labeling machine of claim 18 wherein each of said at least two partial cylindrical form parts comprise a plurality of vacuum openings in an outer circumferential surface thereof, said vacuum openings being configured to be in flow communication with a vacuum source.

20. The labeling machine of claim 19 further comprising:
a label supply apparatus configured to supply uncut labels in strip form; and
said transfer drum being configured to receive uncut labels in strip form from said label supply apparatus, cut uncut labels into individual labels, and transfer cut labels.
